(19) United States
(12) Patent Application Publication
(10) Pub. No.: US 2026/0200487 A1
(43) Pub. Date: Jul. 16, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Yusuke Ogata, Tokyo (JP); Takuya Niioka, Tokyo (JP); Kensuke Arai, Tokyo (JP)

(21) Appl. No.: 19/445,678

(22) Filed: Jan. 12, 2026

(30) Foreign Application Priority Data
Jan. 16, 2025 (JP) 2025-006212

(51) Int. Cl. B60W 50/12; B60W 10/20; B60W 50/08

(52) U.S. Cl. CPC B60W 50/12; B60W 10/20; B60W 50/085; B60W 2520/22; B60W 2540/10; B60W 2710/207; B60W 2720/10; B60W 2720/106

(57) ABSTRACT

A vehicle control device includes a recognizer configured to recognize surroundings of a driving vehicle having a connector and a controller configured to execute driving assistance control for controlling a speed or steering of the driving vehicle based on a recognition result of the recognizer. The controller limits a control amount of the driving assistance control when a driven vehicle is connected to the connector as compared with when the driven vehicle is not connected to the connector.

### CROSS-REFERENCE TO RELATED APPLICATION

Priority is claimed on Japanese Patent Application No. 2025-006212, filed January 16, 2025, the content of which is incorporated herein by reference.

### BACKGROUND OF THE INVENTION

### Field of the Invention

The present invention relates to a vehicle control device, a vehicle control method, and a storage medium.

### Description of Related Art

In recent years, efforts to provide sustainable transportation systems that consider various situations have become more active. For this realization, research and development (R&D) related to driving assistance technologies has focused on further improving traffic safety and convenience. For example, a method for preventing a snaking phenomenon of a trailer characterized in that it is detected on the towing vehicle side for towing a trailer that a braking operation has been performed on a brake pedal, the acceleration of a towing vehicle detected by a towing-vehicle-side acceleration sensor is compared with the acceleration of the trailer detected by a trailer-side acceleration sensor when no braking operation has been performed, and an electromagnetic brake mounted on the trailer is activated to apply braking to the trailer when the latter acceleration is greater than the former acceleration is disclosed (e.g., see Japanese Patent No. 4654420).

### SUMMARY OF THE INVENTION

In conventional technology, it is not possible to appropriately control a vehicle according to a situation.

An aspect of the present invention provides a vehicle control device, a vehicle control method, and a storage medium that can enable a vehicle to be more appropriately controlled during towing. This aspect of the present invention contributes to the development of sustainable transportation systems.

A control device, a control method, and a storage medium according to the present invention adopt the following configurations.

(1): According to an aspect of the present invention, there is provided a vehicle control device including: a recognizer configured to recognize surroundings of a driving vehicle having a connector; and a controller configured to execute driving assistance control for controlling a speed or steering of the driving vehicle based on a recognition result of the recognizer, wherein the controller limits a control amount of the driving assistance control when a driven vehicle is connected to the connector as compared with when the driven vehicle is not connected to the connector.

(2): In the above-described aspect (1), the controller limits the control amount of the driving assistance control so that a snaking phenomenon in which a reference direction of the driven vehicle bends with respect to a reference direction of the driving vehicle and control of the driven vehicle is made difficult is suppressed when the driven vehicle is connected to the connector as compared with when the driven vehicle is not connected to the connector.

(3): In the above-described aspect (1), the vehicle control device further includes an acquirer configured to acquire an angle of a reference direction of the driven vehicle relative to a reference direction of the driving vehicle, wherein the controller increases a limit degree of the control amount based on the angle.

(4): In the above-described aspect (1), the controller limits the control amount of the driving assistance control by suppressing acceleration of the driving vehicle when the driven vehicle is connected to the connector as compared with when the driven vehicle is not connected to the connector.

(5): In the above-described aspect (1), the controller limits the control amount of the driving assistance control so that a change width of a steering angle of the driving vehicle is suppressed when the driven vehicle is connected to the connector as compared with when the driven vehicle is not connected to the connector.

(6): In the above-described aspect (1), the controller limits the control amount of the driving assistance control by suppressing a change in a steering angle of the driving vehicle when the driven vehicle is connected to the connector as compared with when the driven vehicle is not connected to the connector.

(7): In the above-described aspect (1), the controller suppresses an acceleration request of a driver of the driving vehicle when the driven vehicle is connected to the connector as compared with when the driven vehicle is not connected to the connector, or deactivates the acceleration request when the driven vehicle is connected to the connector.

(8): In the above-described aspect (1), the vehicle control device further includes an acquirer configured to acquire an angle of a reference direction of the driving vehicle relative to the connector, wherein the controller limits the control amount of the driving assistance control when the angle changes in a first direction and changes in a second direction opposite to the first direction within a predetermined time and a change degree is greater than or equal to a threshold.

(9): In any one of the above-described aspects (1) to (8), the vehicle control device further includes an acquirer configured to acquire an angle of a reference direction of the driven vehicle relative to a reference direction of the driving vehicle, wherein the controller cancels a limit on the control amount of the driving assistance control when the angle changes from a state in which the angle is changed greater than or equal to a threshold in a predetermined direction to a state in which the angle is less than the threshold.

(10): According to an aspect of the present invention, there is provided a control method including: recognizing, by a computer, surroundings of a driving vehicle having a connector; executing, by the computer, driving assistance control for controlling a speed or steering of the driving vehicle based on a recognition result; and limiting, by the computer, a control amount of the driving assistance control when a driven vehicle is connected to the connector as compared with when the driven vehicle is not connected to the connector.

(11): According to an aspect of the present invention, there is provided a storage medium storing a program for causing a computer to execute: a process for recognizing surroundings of a driving vehicle having a connector; a process for executing driving assistance control for controlling a speed or steering of the driving vehicle based on a recognition result; and a process for limiting a control amount of the driving assistance control when a driven vehicle is connected to the connector as compared with when the driven vehicle is not connected to the connector.

According to the aspects (1) to (11), when the driven vehicle is connected to the connector, the vehicle control device can more appropriately control the vehicle during towing by limiting the control amount of the driving assistance control as compared with when the driven vehicle is not connected to the connector.

According to the aspect (4), the vehicle control device can appropriately control the acceleration and stabilize a traveling state of the vehicle or the driven vehicle by suppressing the acceleration when the driven vehicle is connected to the connector as compared with when the driven vehicle is not connected to the connector.

According to the aspects (5) or (6), the vehicle control device can appropriately control the steering and stabilize the traveling state of the vehicle or the driven vehicle by suppressing an amount of steering control when the driven vehicle is connected to the connector as compared with when the driven vehicle is not connected to the connector.

According to the aspect (7), the vehicle control device can appropriately control the acceleration and stabilize the traveling state of the vehicle or the driven vehicle by suppressing the acceleration for the operation of the driver.

According to the aspect (8), the vehicle control device can appropriately control the driving assistance in accordance with the change level of the angle of the driving vehicle within the predetermined time.

According to the aspect (9), the vehicle control device can implement more appropriate driving assistance control by cancelling the limit on the control amount of the driving assistance control at a timing when the traveling state of the driven vehicle is stable.

### BRIEF DESCRIPTION OF THE DRAWINGS

FIG. 1 is a configuration diagram of a vehicle system using a vehicle control system according to an embodiment.

FIG. 2 is an explanatory diagram of an angle detection process.

FIG. 3 is a diagram showing an example of control results of control according to a comparative example and control according to the present embodiment.

FIG. 4 is a flowchart showing an example of a process executed by a driving assistance device.

FIG. 5 is an explanatory diagram of a normal mode and a towing mode.

FIG. 6 is an explanatory diagram of a process for keeping a change in a steering angle within a predetermined width.

FIG. 7 is an explanatory diagram of a process for limiting a control amount.

FIG. 8 is a diagram showing an example of mode information.

### DETAILED DESCRIPTION OF THE INVENTION

### Overall configuration

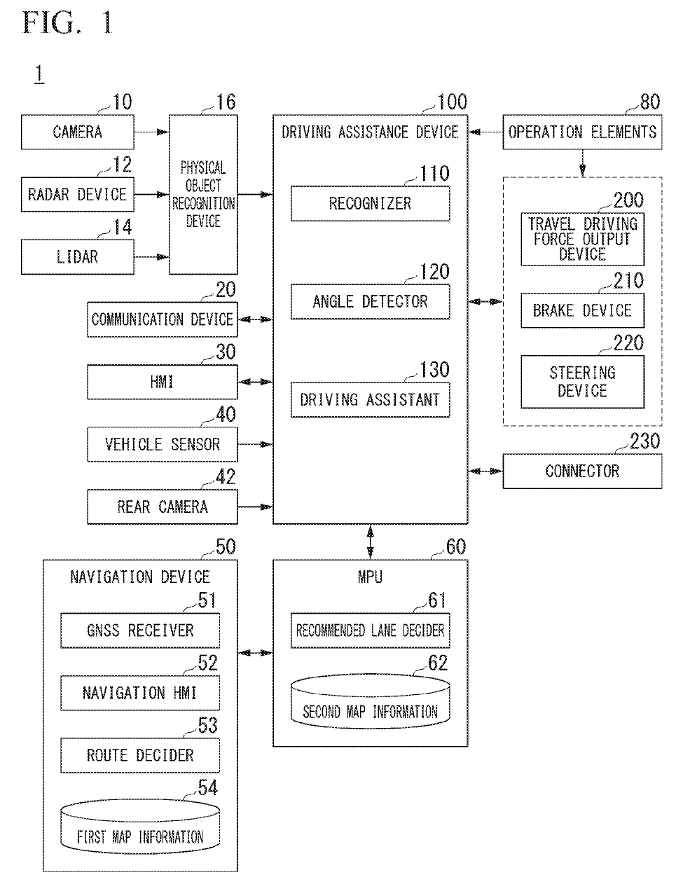

FIG. 1 is a configuration diagram of a vehicle system 1 using a vehicle control system according to an embodiment. A vehicle on which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power when a secondary battery or a fuel cell is discharged. Although the case where the present embodiment is applied to a vehicle will be described, the present invention may be applied to other mobile objects instead of a vehicle.

For example, the vehicle system 1 includes a camera 10, a radar device 12, a light detection and ranging (LIDAR) 14, a physical object recognition device 16, a communication device 20, a human machine interface (HMI) 30, a vehicle sensor 40, a rear camera 42, a navigation device 50, a map positioning unit (MPU) 60, operation elements 80, a driving assistance device 100, a travel driving force output device 200, a brake device 210, a steering device 220, and a connector 230. Such devices and equipment are connected to each other by a multiplex communication line such as a controller area network (CAN) communication line, a serial communication line, or a wireless communication network. The configuration shown in FIG. 1 is merely an example and some of the constituent elements may be omitted or other constituent elements may be further added. The driving assistance device 100 is an example of a “control device.”

For example, the camera 10 is a digital camera using a solid-state imaging element such as a charge-coupled device (CCD) or a complementary metal oxide semiconductor (CMOS). The camera 10 is attached to any location on a vehicle (hereinafter, a vehicle M) where the vehicle system 1 is mounted. When the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position of a physical object (a distance from the physical object and a direction of the physical object) by detecting radio waves (reflected waves) reflected by the physical object. The radar device 12 is attached to any location on the vehicle M. The radar device 12 may detect a position and a speed of the physical object in a frequency-modulated continuous wave (FM-CW) scheme.

The LIDAR 14 radiates light (or electromagnetic waves having a wavelength close to that of light) around the vehicle M and measures scattered light. The LIDAR 14 detects a distance from a target based on a period of time from light emission to light reception. The radiated light is, for example, pulsed laser light. The LIDAR 14 is attached to any location of the vehicle M.

The physical object recognition device 16 performs a sensor fusion process on detection results from some or all of the camera 10, the radar device 12, and the LIDAR 14 to recognize a position, type, speed, and the like of the physical object. The physical object recognition device 16 outputs a recognition result to the driving assistance device 100. The physical object recognition device 16 may output detection results of the camera 10, the radar device 12, and the LIDAR 14 to the driving assistance device 100 as they are. The physical object recognition device 16 may be omitted from the vehicle system 1.

The communication device 20, for example, communicates with another vehicle located in the vicinity of the vehicle M using a cellular network, a Wi-Fi network, Bluetooth (registered trademark), dedicated short-range communication (DSRC), or the like or communicates with various types of server devices via a radio base station.

The HMI 30 presents various types of information to an occupant of the vehicle M and receives an input operation from the occupant. The HMI 30 includes various types of display devices, a speaker, a buzzer, a touch panel, a switch, keys, and the like. The HMI 30 includes a display device. The display device is, for example, a display device, i.e., a multi-information display, provided in a center portion of the instrument panel of the vehicle M and configured to display various information in the vehicle M such as a speedometer indicating a traveling speed of the vehicle M or a tachometer indicating the number of rotations (a rotational speed) of the internal combustion engine provided in the vehicle M.

The vehicle sensor 40 includes a vehicle speed sensor configured to detect the speed of the vehicle M, an acceleration sensor configured to detect acceleration, a yaw rate sensor configured to detect angular velocity around a vertical axis, a direction sensor configured to detect an orientation of the vehicle M, and the like.

The rear camera 42 is a camera that performs an imaging process in a rear direction from the vehicle M. The driving assistance device 100 performs automatic stop control using the image of the rear camera 42. The automatic stop control is a control process in which the vehicle M automatically stops at a predetermined parking position. The rear camera 42, for example, images the connector 230 or images surroundings of the connector 230 together with the connector 230.

For example, the navigation device 50 includes a global navigation satellite system (GNSS) receiver 51, a navigation HMI 52, and a route decider 53. The navigation device 50 holds first map information 54 in a storage device such as a hard disk drive (HDD) or a flash memory. The GNSS receiver 51 identifies a position of the vehicle M based on a signal received from a GNSS satellite. The position of the vehicle M may be identified or complemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route decider 53 decides a route (hereinafter referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may provide route guidance using the navigation HMI 52 based on the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

The MPU 60 includes, for example, a recommended lane decider 61, and holds second map information 62 in a storage device such as an HDD or a flash memory. The recommended lane decider 61 divides the route on the map provided from the navigation device 50 into a plurality of blocks (e.g., divides the route every 100 [m] in a travel direction of the vehicle), and decides a recommended lane for each block with reference to the second map information 62. The recommended lane decider 61 decides in what lane numbered from the left the vehicle will travel. The recommended lane decider 61 decides the recommended lane so that the vehicle M can travel along a reasonable route for traveling to a branching destination when there is a branch point on the route on the map. For example, when the vehicle M reaches a position that is a predetermined distance before a branch path that the vehicle M is scheduled to enter, the recommended lane decider 61 decides a lane connecting to the branch path as the recommended lane. The recommended lane decider 61 and the second map information 62 may be a functional unit or information included in another device such as the driving assistance device 100. The driving assistance device 100 recommends the driver to move the vehicle M to the recommended lane or automatically moves the vehicle M.

The second map information 62 is map information with higher accuracy than the first map information 54. The second map information 62 includes, for example, information about a center of a lane, information about a boundary of the lane, or the like. The second map information 62 may include road information, traffic regulation information, address information (address/postal code), facility information, telephone number information, and the like. The second map information 62 may be updated at any time by the communication device 20 communicating with other devices.

The operation elements 80 include, for example, a steering wheel, an accelerator pedal, a brake pedal, a shift lever, and other operation elements. A sensor for detecting an amount of operation or the presence or absence of an operation is attached to the operation element 80 and a detection result thereof is output to the driving assistance device 100 or some or all of the travel driving force output device 200, the brake device 210, and the steering device 220. The steering wheel does not necessarily have to be annular and may be in the form of a variant steering wheel, a joystick, a button, or the like.

The driving assistance device 100 includes, for example, a recognizer 110, an angle detector 120, and a driving assistant 130. The recognizer 110, the angle detector 120 (an acquirer), and the driving assistant 130 are implemented, for example, by a hardware processor such as a central processing unit (CPU) executing a program (software). Some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The program may be pre-stored in a storage device (a storage device including a non-transitory storage medium) such as an HDD or a flash memory in the driving assistance device 100 or may be stored in a removable storage medium such as a DVD or a CD-ROM and installed in an HDD or a flash memory of the driving assistance device 100 when the storage medium (the non-transitory storage medium) is mounted in a drive device.

On the basis of information input from the camera 10, the radar device 12, and the LIDAR 14 via the physical object recognition device 16, the recognizer 110 recognizes a state of a position, velocity, acceleration, or the like of a physical object in the vicinity of the vehicle M. The position of the physical object, for example, is recognized as a position of an absolute coordinate system having a representative point of the vehicle M (a center of gravity, a drive shaft center, or the like) as the origin, and is used for control. The position of the physical object may be represented by a representative point such as the center of gravity or a corner of the physical object or may be represented by an area. The “state” of the physical object may include the acceleration or jerk of the physical object, or the “action state” (e.g., whether or not the vehicle is changing lanes or is about to change lanes).

The recognizer 110 recognizes a lane in which the vehicle M is traveling (a travel lane). For example, the recognizer 110 recognizes the travel lane by comparing a pattern of road markings (e.g., an arrangement of solid lines and broken lines) obtained from the second map information 62 with a pattern of road markings in the vicinity of the vehicle M recognized from an image captured by the camera 10. The recognizer 110 may recognize the travel lane by recognizing a travel path boundary (a road boundary) including a road marking, a road shoulder, a curb, a median strip, a guardrail, and the like as well as a road marking. In this recognition, a position of the vehicle M acquired from the navigation device 50 or a processing result of the INS may be taken into account. The recognizer 110 recognizes a temporary stop line, an obstacle, a red traffic light, and a toll gate, and other road events.

When the travel lane is recognized, the recognizer 110 recognizes a position or an orientation of the vehicle M with respect to the travel lane. For example, the recognizer 110 may recognize a deviation of a reference point of the vehicle M from the center of the lane and an angle formed between the travel direction of the vehicle M and a line connected to the center of the lane as a relative position and orientation of the vehicle M related to the travel lane. Alternatively, the recognizer 110 may recognize the position of the reference point of the vehicle M for any side end of the travel lane (the road marking or the road boundary) or the like as a position of the vehicle M relative to the travel lane.

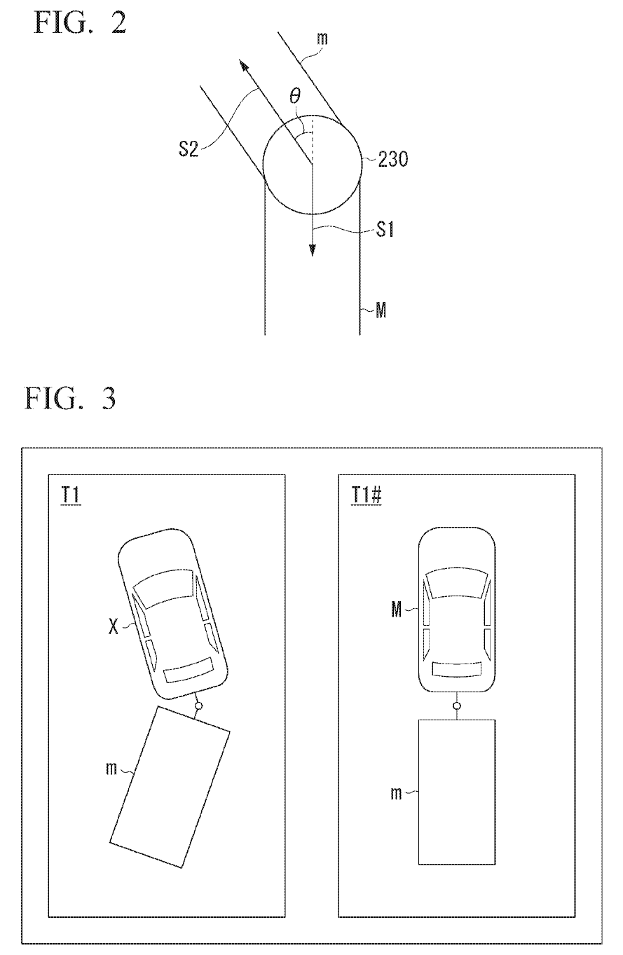

The angle detector 120 detects an angle of the driven vehicle relative to the vehicle M (or the connector 230) and an angle of the vehicle M or the driven vehicle relative to the connector 230. FIG. 2 is an explanatory diagram of an angle detection process. As shown in the FIG. 2, the driven vehicle m is connected to the connector 230 of the vehicle M. The state of the driven vehicle m changes with a traveling state of the vehicle M. The angle detector 120 detects an angle θ of a reference direction S2 of a support of the driven vehicle m relative to a reference direction S1 of a support of the vehicle M. This angle θ is an angle that increases as the travel direction of the driven vehicle m deviates (or bends) from the travel direction of the vehicle M. The angle detector 120 analyzes the image captured by the rear camera 42 and obtains the angle θ. In addition, a mark indicating the reference direction S1 or a mark indicating the reference direction S2 may be assigned to the vehicle M, the connector 230, and the driven vehicle m. As described above, the angle detector 120 can detect the angle θ.

Although a case where the angle θ is detected by image analysis has been described, the angle detector 120 may detect the angle θ with reference to a detection result of an angle sensor provided at or near the connector 230 in place thereof (in addition thereto).

The driving assistant 130 executes driving assistance control. For example, the driving assistant 130 automatically controls the travel driving force output device 200 and the brake device 210 without relying on the driver’s operation, thereby automatically controlling the speed of the vehicle M. The driving assistant 130 executes so-called adaptive cruise control (ACC). The driving assistant 130 controls the vehicle M so that the vehicle M travels at a set speed, or causes the vehicle M to travel while tracking a preceding vehicle at a predetermined distance from the preceding vehicle.

The driving assistant 130 controls the steering device 220 so that the vehicle M does not deviate from the travel lane. For example, the driving assistant 130 controls the steering device 220 so that the vehicle M travels near or along the center of the travel lane recognized by the recognizer 110. This control may hereinafter be referred to as “lane keeping control.” The controller 150 executes both hands-on lane keeping control and hands-off lane keeping control.

The hands-on lane keeping control is a control process that is executed in a state in which the driver is grasping the steering wheel (a state in which a steering grasp sensor (not shown) detects the grasping of the steering wheel). A condition under which the hands-on lane keeping control is executable is looser than that under which the hands-off lane keeping control is executable.

The hands-off lane keeping control is a control process that is executed in a state in which the driver is not grasping the steering wheel (a state in which the steering grasp sensor (not shown) does not detect the grasping of the steering wheel). The hands-off lane keeping control is executable, for example, if the following conditions are satisfied. The conditions are that the speed of the vehicle M is greater than or equal to a predetermined speed, that the vehicle M is traveling on a predetermined road (e.g., a road or a type of road where the hands-off lane keeping control is preset to be executable), and that the driver is performing forward monitoring. The hands-off lane keeping control is performed when the driver is performing forward monitoring and the hands-off lane keeping control is not executed or stopped when the driver is not performing forward monitoring.

The above-described conditions under which the hands-on lane keeping control and the hands-off lane keeping control are executable are examples, and may include other conditions (e.g., the vehicle M is tracking a preceding vehicle) or some conditions may be omitted. It is only necessary for the condition under which the hands-on lane keeping control is executable to be looser than the condition under which the hands-off lane keeping control is executable (it is only necessary for the conditions under which the hands-off lane keeping control is executable to be stricter than the condition under which the hands-on lane keeping control is executable). In addition, whether the driver is performing forward monitoring is recognized by the driving assistance device 100 based on the image captured by the camera that images the driver (not shown).

The travel driving force output device 200 outputs a travel driving force (torque) for enabling the traveling of the vehicle to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the driving assistance device 100 or information input from the operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the driving assistance device 100 or the information input from the operation element 80 so that brake torque according to a braking operation is output to each wheel.

For example, the steering device 220 includes a steering ECU and an electric motor. For example, the electric motor changes directions of steerable wheels by applying a force to a rack and pinion mechanism. The steering ECU drives the electric motor in accordance with the information input from the driving assistance device 100 or the information input from the operation element 80 to change the directions of the steerable wheels.

The connector 230 is a connector that is connected to the driven vehicle m towed by the vehicle M. When the driven vehicle m is connected to the connector 230, the vehicle M can tow the driven vehicle m. For example, the support of the vehicle M and the connector 230 are connected and the connector 230 and the support of the driven vehicle m are connected, so that the vehicle M and the driven vehicle m are connected.

### Overview

The driving assistance device 100 limits a control amount of the driving assistance control when the driven vehicle m is connected to the connector 230 as compared with when the driven vehicle m is not connected to the connector 230. Thereby, the driving assistance device 100 can more appropriately control the vehicle M during towing. The control amount of the driving assistance control is the control amount for changing a speed, acceleration, and steering. A process for limiting the control amount is a process for suppressing a change in the speed, acceleration, or steering.

The driving assistance device 100 limits the control amount of the driving assistance control when the driven vehicle m is connected to the connector 230 as compared with when the driven vehicle m is not connected to the connector 230 so that a snaking phenomenon in which a reference direction of the driven vehicle m bends with respect to a reference direction of the vehicle M (driving vehicle) and control of the driven vehicle m is made difficult is suppressed. The reference direction is any direction such as the travel direction or the direction of the support of the connector.

The driving assistance device 100 increases the limit on the control amount of the driving assistance control based on the angle of the reference direction of the driven vehicle m relative to the reference direction of the vehicle M detected by the angle detector 120. For example, as the angle increases, the control level increases.

For example, the driving assistance device 100 may reduce the speed (speed or acceleration) of the vehicle M and suppress the change in the steering of the predetermined level or more when a state in which the angle of the reference direction of the driven vehicle m relative to the reference direction of the vehicle M is greater than or equal to the threshold continues for a predetermined period of time. For example, an increase in the speed of vehicle M is automatically suppressed and a control process is performed so that the steering change is automatically suppressed to stabilize the states of the vehicle M and the driven vehicle m.

FIG. 3 shows an example of control results of the control of the comparative example and the control of the present embodiment. In the scene of T1 in FIG. 3, the vehicle X in the comparative example is towing the driven vehicle m and executing the driving assistance control (control of the speed, acceleration, or steering). In this case, the vehicle X will execute the driving assistance control like the driving assistance control when the driven vehicle m is not towed (the control amount shall not be limited). At this time, the driving assistance control of the vehicle M may cause the driven vehicle m to sway and the control of the vehicle X or the driven vehicle m may not be effective.

On the other hand, in the present embodiment, as shown in a scene T# in FIG. 3, because the control amount of the driving assistance control is limited or an increase in the control amount is suppressed, the behavior of the vehicle M, which causes the driven vehicle m to sway, is suppressed. Thereby, the driven vehicle m travels in the same direction as the vehicle M. As described above, the driving assistance device 100 can control the vehicle M more appropriately so that the traveling of the driven vehicle m is stable.

In the above-described process, the driving assistance device 100 may cancel the limit on the control amount of the driving assistance control when the angle of the reference direction of the driven vehicle m relative to the reference direction of the vehicle M falls within a predetermined angle range by suppressing the control amount. The driving assistance device 100 may cancel the limit on the control amount of the driving assistance control when the angle changes from a state in which the angle of the reference direction of the driven vehicle m relative to the reference direction of the vehicle M is greater than or equal to the threshold in a predetermined direction to a state in which the angle of the reference direction of the driven vehicle m is less than the threshold (when the angle approaches the angle of the reference direction such as the travel direction of the vehicle M). For example, the acceleration limit may be cancelled. As a result, the driving assistance device 100 can control the vehicle M without excessively suppressing an increase in the control amount while suppressing the snaking phenomenon.

### Flowchart

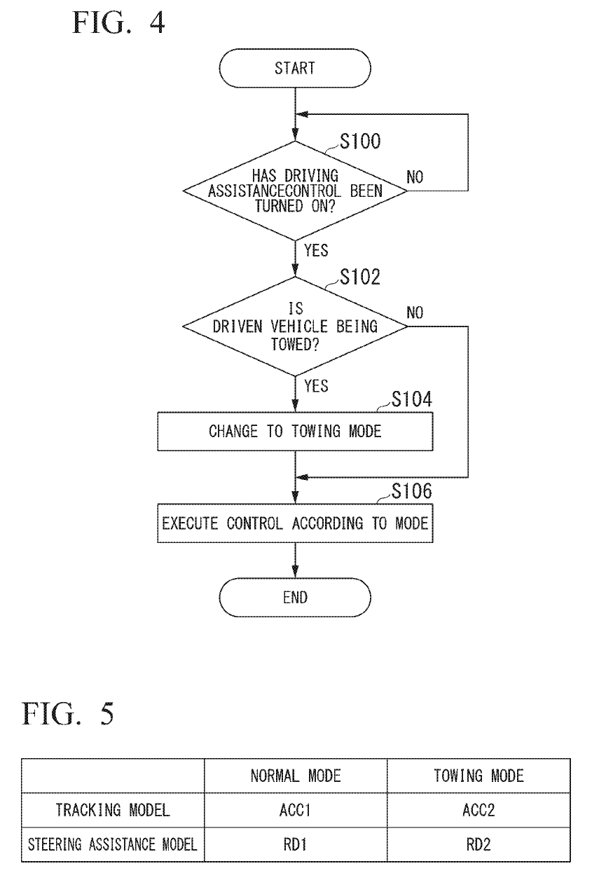

FIG. 4 is a flowchart showing an example of a flow of a process performed by the driving assistance device 100. First, the driving assistance device 100 determines whether or not the driving assistance control is turned on (step S100). For example, the driving assistance control is turned on when the driver operates a predetermined button.

When the driving assistance control is turned on, the driving assistance device 100 determines whether or not the vehicle M is towing the driven vehicle m (S102). The driving assistance device 100 may determine whether or not vehicle M is towing the driven vehicle m when the information indicating that towing is being performed by the driver is input (when an operation indicating that the towing is being performed is performed), or may determine whether or not the vehicle M is towing the driven vehicle m based on the output of the drive source and the traveling state such as the speed or acceleration of the vehicle M.

When the vehicle M is not towing the driven vehicle m, the processing of step S104 is skipped and the driving assistance device 100 executes the driving assistance control based on a normal mode of the driving assistance control (step S106).

When the vehicle M is towing the driven vehicle m, the driving assistance device 100 changes the mode of the driving assistance control from the normal mode to a towing mode (step S104) and executes the driving assistance control based on the towing mode (step S106). The towing mode is a mode in which changes in the speed, acceleration, steering, or all of these are suppressed as compared to the normal mode.

For example, when the snaking phenomenon is occurring or is likely to occur, the strong control intervention of the steering may cause a stronger snaking phenomenon or induce a snaking phenomenon. As described above, the driving assistance device 100 executes the driving assistance control by suppressing the control amount of the driving assistance control before the snaking phenomenon occurs and suppressing the control amount so that the snaking phenomenon is prevented from occurring in the towing mode. Thereby, the traveling of the vehicle M and the driven vehicle m is stabilized.

### Towing mode

FIG. 5 is an explanatory diagram of the normal mode and the towing mode. Control amounts of one or both of the normal mode and the towing mode are different between a tracking model and a steering assistance model. The control amount in the towing mode is suppressed as compared with that in the normal mode. The tracking model is a model that includes acceleration and the like when the speed of the vehicle M to be used approaches a target speed when ACC is executed. The steering assistance model is a model including the trend of the change in the steering and the like when the vehicle M is brought closer to the center of the lane, which is used when lane keeping control is executed.

### Suppression of Acceleration

For example, the acceleration of a tracking model ACC2 in the towing mode is suppressed as compared with the acceleration of a tracking model ACC1 in the normal mode. Specifically, the acceleration when the vehicle M reaches the target speed in the tracking model ACC2 in the towing mode is suppressed as compared with the acceleration when the vehicle M reaches the target speed in the tracking model ACC1 in the normal mode. In other words, the time for the vehicle M to reach the target speed in the tracking model ACC2 in the towing mode is longer than the time for the vehicle M to reach the target speed in the tracking model ACC1 in the normal mode. In this way, the driving assistance device 100 limits the control amount of the driving assistance control by suppressing the acceleration of the vehicle M when the driven vehicle m is connected to the connector 230 as compared with when the driven vehicle m is not connected to the connector 230. Thereby, it is possible to stabilize the traveling of the vehicle M or the driven vehicle m.

The driving assistance device 100 may suppress an acceleration request of the driver of the vehicle M when the driven vehicle m is connected to the connector 230 as compared with when the driven vehicle m is not connected to the connector 230. The acceleration request is, for example, an acceleration operation by the operation of the access pedal by the driver. For example, the driving assistance device 100 accelerates the vehicle M with first acceleration when a first acceleration request is made when the driven vehicle m is not connected to the connector 230. For example, the driving assistance device 100 accelerates the vehicle M with second acceleration when the first acceleration request is made in a case the driven vehicle m is connected to the connector 230. The second acceleration is acceleration less than or equal to a preset threshold and is less than the first acceleration. This process can be performed while ACC is in execution, or can be performed when the ACC is not in execution.

The driving assistance device 100 may deactivate the acceleration request of the driver of the vehicle M when the driven vehicle m is connected to the connector 230. For example, when the ACC is in execution, for example, the vehicle M travels based on the tracking model ACC2 in the towing mode.

As described above, the driving assistance device 100 can suppress the snaking phenomenon and the unstable behavior of the driven vehicle m by suppressing the acceleration or the change in the acceleration of vehicle M when the vehicle M is towing the driven vehicle m.

### Steering Suppression 1

For example, the control amount of the steering of a steering assistance model RD1 in the towing mode is suppressed compared to the control amount of the steering in a steering assistance model RD2 in the normal mode. Specifically, a change degree of the steering angle of the vehicle M in the steering assistance model RD1 in the towing mode is suppressed compared to a change degree of the steering angle of the vehicle M in the steering assistance model RD2 in the normal mode.

The driving assistance device 100, for example, limits the control amount of the steering assistance so that a change width of the steering angle of the vehicle M is suppressed when the driven vehicle m is connected to the connector 230 as compared with when the driven vehicle m is not connected to the connector 230.

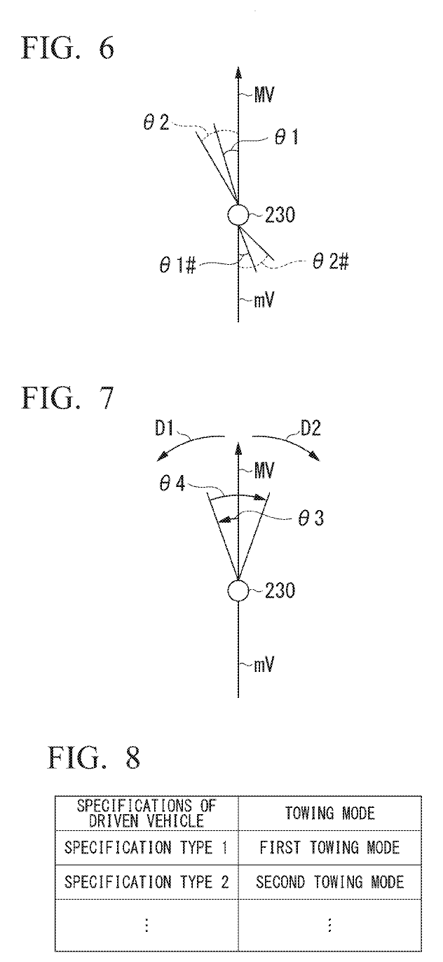

FIG. 6 is an explanatory diagram of a process of keeping a change in a steering angle within a predetermined width. A reference direction MV is, for example, a travel direction of the vehicle M, and a reference direction mV is a reference direction (a travel direction or a direction opposite to the travel direction) of the driven vehicle m. In the steering assistance model RD1 in the normal mode, the steering angle in which the reference direction MV of the vehicle M changes to a range of an angle θ2 is allowed. In the steering assistance model RD2 in the towing mode, the steering angle in which the reference direction MV of the vehicle M changes to the range of the angle θ2 is not allowed. For example, in the steering assistance model RD2 in the towing mode, the steering angle in which the reference direction MV of the vehicle M changes to a range of an angle θ1 is allowed. In other words, in the steering assistance model RD2 in the towing mode, the control amount of the steering assistance is limited so that the change in the steering angle of the vehicle M is within the predetermined width (the change in the travel direction of the vehicle M is within the range of the angle θ2).

If the reference direction MV changes to the angle θ2 within a predetermined time, the reference direction mV changes to an angle θ2#, and the traveling of the driven vehicle m may become unstable. On the other hand, if the reference direction MV is suppressed to a change up to the angle θ1, the reference direction mV changes to an angle θ1#, but additional changes are suppressed, and the traveling of the driven vehicle m is stable, and the snaking phenomenon is suppressed.

### Steering Suppression 2

The driving assistance device 100 may limit the control amount of the driving assistance control by suppressing the change in the steering angle of the vehicle M when the driven vehicle m is connected to the connector 230 as compared with when the driven vehicle m is not connected to the connector 230. The driving assistance device 100, for example, may limit the control amount of the driving assistance control by transmitting a reaction force to the steering wheel in conjunction with the steering ECU to suppress changes in the steering angle. Thereby, the driving assistance device 100 can suppress the steering angle of the vehicle M even if the driver tries to change the steering wheel by a certain degree or more. For example, the change in the steering angle (such as the change in the angle and the amount of change per unit of time) is suppressed by a reaction force that suppresses the rotation of the steering wheel. In this process, a suppression level is also a level to which the snaking phenomenon is suppressed. For example, the suppression level is a suppression level for preventing the reference direction MV of the vehicle M from exceeding the range of the angle θ. Thereby, the driving assistance device 100 can stabilize the driving of the driven vehicle m and suppress the snaking phenomenon.

### Steering Suppression 3

The driving assistance device 100 may limit the control amount of the driving assistance control when, within a predetermined time, the angle of the vehicle M for the connector 230 relative to the reference direction changes in a first direction and then changes in a second direction that is a direction opposite to the first direction, and a level of the above-described change is greater than or equal to a threshold. FIG. 7 is an explanatory diagram of a process for limiting the control amount. It is assumed that the reference direction MV rotates at an angle θ3 in a first direction D1 and then the reference direction MV rotates at an angle θ4 in a second direction D2 which is a direction opposite to the first direction D1, within the predetermined time. In this case, when a total angle (change level) of the angle θ3 and the angle θ4 or the angle θ4 (change level) is greater than or equal to the threshold, the control amount of the driving assistance control is limited. For example, the control amount of the acceleration or steering is limited. Thereby, the driving assistance device 100 can stabilize the traveling of the driven vehicle m and suppress the snaking phenomenon.

In addition, in each of the above-described processes, an angle of the reference direction MV of the vehicle M relative to the connector 230 may be used as an angle of a determination target, and an angle of the reference direction MV of the vehicle M relative to the reference direction mV of the driven vehicle m may be used. In addition, a relationship between a direction based on the driven vehicle m or the support of the driven vehicle m and a reference direction of the vehicle M or the support or connector of the vehicle M may be used. As described above, it is only necessary to use a direction that changes with the behavior of the vehicle M and a direction that changes with the behavior of the driven vehicle m.

### Consideration of Specifications

The driving assistance device 100 may change a limit amount of the driving assistance control based on the specifications of the driven vehicle m. Specifications are, for example, a weight, a length, a width, a wheelbase of the driven vehicle m, an inter-tire length in relation to the width direction of the driven vehicle m, a distance from the connector 230 to the reference position when the driven vehicle m is connected to the connector 230, and the like. The reference position is, for example, a position of the front wheel, a position of a distal end of the driven vehicle m, or the like.

For example, the storage of the driving assistance device 100 registers information about the specifications of the driven vehicle m registered by the driver or the like. Furthermore, the storage stores mode information associated with a corresponding relationship between a specification type and the towing mode according to the information about the specifications.

FIG. 8 shows an example of the mode information. For example, the driving assistance device 100 identifies a specification type according to the specification information among a plurality of specification types, and the towing mode according to the identified specification type is identified. Specifically, for example, a weight range, a length range, a wheelbase range, and the like are specified for each specification type, and the specification type matching the specification information of the driven vehicle m is identified, and the towing mode according to the specification type is identified.

In the towing mode associated with the specification type, a control amount or a limit degree of the control amount are set to stabilize the traveling of the driven vehicle m of the specification type. For example, the limit degree of the control amount of the first towing mode is greater than the limit degree of the control amount of the second towing mode. A higher limit degree means, for example, that the acceleration is more strongly suppressed or that the change amount of the steering is more strongly suppressed.

As mentioned above, the driving assistance device 100 can implement appropriate control according to the specifications of the driven vehicle m.

Moreover, determination criteria such as the threshold for the angle of each of the above-described process and the time used for the determination (e.g., a predetermined time) may be set based on the speed of the vehicle M or the driven vehicle m.

According to the embodiment described above, the driving assistance device 100 executes driving assistance control for controlling a speed or steering of the driving vehicle based on a result of recognizing surroundings of a driving vehicle (vehicle M) having the connector 230 and limits a control amount of the driving assistance control when the driven vehicle m is connected to the connector 230 as compared with when the driven vehicle m is not connected to the connector 230, whereby it is possible to implement more appropriate vehicle control during towing.

The embodiment described above can be represented as follows.

A control device including:

a storage device storing a program; and

a hardware processor, the hardware processor executing the program stored in the storage device to:

recognize surroundings of a driving vehicle having a connector;

execute driving assistance control for controlling a speed or steering of the driving vehicle based on a recognition result of the recognizer; and

limit a control amount of the driving assistance control when a driven vehicle is connected to the connector as compared with when the driven vehicle is not connected to the connector.

Although modes for carrying out the present invention have been described using embodiments, the present invention is not limited to the embodiments and various modifications and substitutions can also be made without departing from the scope of the present invention.

What is claimed is:

1. A vehicle control device comprising:
a recognizer configured to recognize surroundings of a driving vehicle having a connector; and
a controller configured to execute driving assistance control for controlling a speed or steering of the driving vehicle based on a recognition result of the recognizer,
wherein the controller limits a control amount of the driving assistance control when a driven vehicle is connected to the connector as compared with when the driven vehicle is not connected to the connector.

2. The vehicle control device according to claim 1, wherein the controller limits the control amount of the driving assistance control so that a snaking phenomenon in which a reference direction of the driven vehicle bends with respect to a reference direction of the driving vehicle and control of the driven vehicle is made difficult is suppressed when the driven vehicle is connected to the connector as compared with when the driven vehicle is not connected to the connector.

3. The vehicle control device according to claim 1, further comprising an acquirer configured to acquire an angle of a reference direction of the driven vehicle relative to a reference direction of the driving vehicle,
wherein the controller increases a limit degree of the control amount based on the angle.

4. The vehicle control device according to claim 1, wherein the controller limits the control amount of the driving assistance control by suppressing acceleration of the driving vehicle when the driven vehicle is connected to the connector as compared with when the driven vehicle is not connected to the connector.

5. The vehicle control device according to claim 1, wherein the controller limits the control amount of the driving assistance control so that a change width of a steering angle of the driving vehicle is suppressed when the driven vehicle is connected to the connector as compared with when the driven vehicle is not connected to the connector.

6. The vehicle control device according to claim 1, wherein the controller limits the control amount of the driving assistance control by suppressing a change in a steering angle of the driving vehicle when the driven vehicle is connected to the connector as compared with when the driven vehicle is not connected to the connector.

7. The vehicle control device according to claim 1, wherein the controller suppresses an acceleration request of a driver of the driving vehicle when the driven vehicle is connected to the connector as compared with when the driven vehicle is not connected to the connector, or deactivates the acceleration request when the driven vehicle is connected to the connector.

8. The vehicle control device according to claim 1, further comprising an acquirer configured to acquire an angle of a reference direction of the driving vehicle relative to the connector,
wherein the controller limits the control amount of the driving assistance control when the angle changes in a first direction and changes in a second direction opposite to the first direction within a predetermined time and a change degree is greater than or equal to a threshold.

9. The vehicle control device according to claim 1, further comprising an acquirer configured to acquire an angle of a reference direction of the driven vehicle relative to a reference direction of the driving vehicle,
wherein the controller cancels a limit on the control amount of the driving assistance control when the angle changes from a state in which the angle is changed greater than or equal to a threshold in a predetermined direction to a state in which the angle is less than the threshold.

10. A vehicle control method comprising:
recognizing, by a computer, surroundings of a driving vehicle having a connector;
executing, by the computer, driving assistance control for controlling a speed or steering of the driving vehicle based on a recognition result; and
limiting, by the computer, a control amount of the driving assistance control when a driven vehicle is connected to the connector as compared with when the driven vehicle is not connected to the connector.

11. A computer-readable non-transitory storage medium storing a program for causing a computer to execute:
a process for recognizing surroundings of a driving vehicle having a connector;
a process for executing driving assistance control for controlling a speed or steering of the driving vehicle based on a recognition result; and
a process for limiting a control amount of the driving assistance control when a driven vehicle is connected to the connector as compared with when the driven vehicle is not connected to the connector.
